(19) United States
(12) Patent Application Publication
(10) Pub. No.: US 2014/0258860 A1
(43) Pub. Date: Sep. 11, 2014

(54) SYSTEM AND METHOD FOR PROVIDING FEEDBACK TO THREE-TOUCH STROKE MOTION

(71) Applicant: Srinivasan Subramanian, Palo Alto, CA (US)

(72) Inventor: Srinivasan Subramanian, Palo Alto, CA (US)

(21) Appl. No.: 13/788,961

(22) Filed: Mar. 7, 2013

(51) Int. Cl. G06F 3/0488; G06F 3/01

(52) U.S. Cl. CPC G06F 3/0488; G06F 3/016
USPC 715/716; 345/173

(57) ABSTRACT

A system for providing tactile/audible feedback to three-touch stroke motion. The system includes a multi-touch device operable to produce an event signal by detecting any touch-motion event by one or more user-controlled objects. The touch-motion event includes a three-touch stroke motion characterized by substantially simultaneous three-point touch followed by a stroke motion along the multi-touch device before lifting the user-controlled objects. The system further includes a controller configured to process the event signal and generate a drive signal for an event dispatcher. Additionally, the system includes an event handler being coupled to the event dispatcher to subscribe the drive signal. The event handler is configured to select a graphic object that is enabled with the drive signal specifically associated with the three-touch stroke motion applied to said graphic object on the touch device to provide either a tactile response or an audible response or both.

### BACKGROUND OF THE INVENTION

The present invention relates generally to touch screen technology. More particularly, the present invention provides a system and method for providing tactile and audible feedbacks to a three-touch stroke motion. Merely by way of example, the present invention implement an application for utilizing the three-point touch and stroke motion applied on a graphic object displayed on a touch device to induce a vibration of the device or play a sound from a pre-stored audio file or do both. This invention is applicable in any portable devices/toys or personal, household, building object equipped with a functional touch device, but it would be recognized that the invention may have many other applications for technical and practical usage or entertainment.

Many hand-held and/or portable electronic devices or toys, such as laptop computers, personal digital assistants (PDA), wireline or wireless telephones, video games and other similar electronic devices are equipped with a touch device and also used as a simple graphical input device for users. The touch device has been widely implemented to provide position signal caused by touch of any user-controlled object and to detect subsequent motion after the touch to further classify a touch event. A controller or more advanced operating system process these touch event signals to generate user-interface feedbacks for many graphical applications. For example, the user uses his/her fingers to make the touch. Several finger gestures are classified to allow user to make specific interaction with the graphical application by manipulating the graphical objects displayed on a display area of the touch device.

Among typical touch gestures supported by current mobile operating system, some are listed here: 1) A tap includes a press followed by a lift motion, which triggers a default functionality for a given item. 2) A long press includes a press, and wait, followed by a lift motion, which is used for entering data-selection mode. 3) A swipe or flick/scroll includes press, move and lift, which is used for scrolling overflowing content or web navigation. 4) A drag includes long press, move, and lift, which rearranges data within a view, or move data into a container. 5) A double tap includes two touches in quick succession, which is used for zooming into content or a secondary gesture for text selection. 6) A pinch open includes two-finger press, move outwards, and lift, which is for zooming into content. 7) A pinch close includes also a two-finger press but move inwards, and lift, which is for zooming out of content. 8) A rotate includes two touches with one fixed in position while the other moved clockwise/counterclockwise for rotating a graphic object. A reference of these functional gestures can be found in the website: http://en.wikipedia.org/wiki/Multi-touch. Among these touch-motion modes, some feedback features are enabled for the user to apply single-point touch for key-board typing, icon selecting, image selecting, clicking for web surfing, stroking for swiping overflowing web page up and down or flipping pages of an e-book, and others require user to apply two-point touch for zooming (a web page or an image), rotating an on-screen object (2D or 3D) and others. The touch object can also be realized by a stylus, making some applications more convenient but causing no fundamental difference in feedback features.

However, no three-finger touch or more generally three-touch motion is implemented for any touch-response in graphical applications. It is seen that a system and method for providing tactile and/or audible response to three-touch stroke motion are desired and corresponding application for mobile device or toy pets is introduced for entertainment or other purposes.

### BRIEF SUMMARY OF THE INVENTION

The present invention relates generally to touch screen technology. More particularly, the present invention provides a system and method for providing tactile and audible feedbacks to a three-touch stroke motion. Merely by way of example, the present invention implement an application for utilizing the three-point touch and stroke motion applied on a graphic object displayed on a touch device to induce a vibration of the device or play a sound from a pre-stored audio file or may repeat many times on either or both responses. This invention is applicable in any portable devices/toys or any personal, household, building object equipped with a functional touch device, but it would be recognized that the invention may have many other applications for technical and practical usage or entertainment.

In a specific embodiment, the present invention provides a system for providing tactile and audible feedbacks to three-touch stroke motion. The system includes a multi-touch device having a display area operable to produce an event signal by detecting any touch-motion event by one or more user-controlled objects. The touch-motion event includes a three-touch stroke motion characterized by substantially simultaneous three-point touch followed by a stroke motion along the multi-touch device before lifting the user-controlled objects from the display area. Additionally, the system includes a controller configured to process the event signal and generate a drive signal for an event dispatcher. Moreover, the system includes an event handler being coupled to the event dispatcher to subscribe the drive signal. The event handler is configured to select a graphic object to display on the display area. The selected graphic object is enabled with the drive signal specifically associated with the three-touch stroke motion applied to said graphic object to provide either a tactile response or an audible response or both.

In another specific embodiment, the present invention provides a method for providing tactile and/or audible feedbacks to three-touch stroke motion on a touch device. The method includes enabling a user-interface (UI) application by storing a computer-readable code to a memory associated with an event handler. The computer-readable code is configured to respond to a drive signal generated by a controller by processing an event signal received from a touch device configured to detect any touch-motion event by one or more user-controlled objects. The method further includes launching the UI application and selecting a graphic object associated with the UI application to display on a display area of the touch device. Additionally, the method includes selecting an audio file associated with the graphic object and applying user-controlled objects to cause a touch-motion event characterized by exact three touches at a time on the displayed graphic object followed by a stroke motion along the touch device before lifting. The method further includes detecting the touch-motion event by the touch device to produce a first event signal associated with the three-touch stroke motion. Furthermore, the method includes processing the first event signal by the controller to generate a first drive signal for an event dispatcher. Moreover, the method includes dispatching the first drive signal to the event handler to play an audio based on the audio file.

In yet another embodiment, a functional gesture applying on a touch device is provided in the present invention. The functional gesture includes a substantially simultaneous three-finger press on the touch device configured to detect a position signal for each individual touch. Additionally, the functional gesture includes a stroke motion following the three-finger press wherein the three fingers remain in touch with the touch device. Moreover, the functional gesture includes a lift motion at the end of the stroke motion wherein all fingers move away from the touch device. In an embodiment, the three-finger press is applied on a graphic object displayed on the touch device and enabled by a user-interface application, and the three-finger press followed by the stroke motion and lift motion induces a tactile/audible response programmable by the user-interface application.

### BRIEF DESCRIPTION OF THE DRAWINGS

FIG. 1 is a schematic diagram showing a three-touch press applied on a touch device according to an embodiment of the present invention.

FIG. 2 is a schematic diagram showing a three-touch stroke motion along the touch device according to an embodiment of the present invention.

FIG. 3A is a schematic diagram showing a three-touch stroke motion applied on a graphic object displayed on the touch device according to an embodiment of the present invention.

FIG. 3B is a schematic diagram showing a tactile/audible response to the three-touch stroke motion applied on a graphic object displayed on the touch device according to an embodiment of the present invention.

FIG. 4 is a block diagram showing a process flow in association with a system to initiate a three-touch stroke motion for inducing a tactile/audible response according to an embodiment of the present invention.

FIG. 5 is a functional block diagram for implementing a user-interface application enabling tactile and/or audible response to three-touch stroke motion on a graphic object on a touch device according to an embodiment of the present invention.

FIG. 6 is a simplified diagram showing an exemplary user-interface application having a set button, an image loader button, and an audio loader button according to an embodiment of the present invention.

FIG. 7 is a flow chart showing a method for providing tactile/audible feedbacks to three-touch stroke motion in a user-interface application according to an embodiment of the present invention.

### DETAILED DESCRIPTION OF THE INVENTION

The present invention relates generally to touch screen technology. More particularly, the present invention provides a system and method for providing tactile and audible feedbacks to a three-touch stroke motion. Merely by way of example, the present invention implement an application for utilizing the three-point touch and stroke motion applied on a graphic object displayed on a touch device to induce a tactile or audible response or both. This invention is applicable in any portable devices/toys or any personal, household, building object equipped with a functional touch device, but it would be recognized that the invention may have many other applications for technical and practical usage or entertainment.

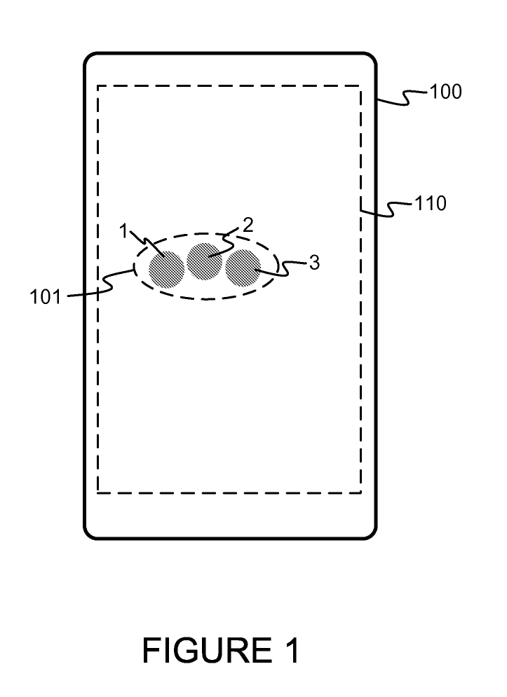

FIG. 1 is a schematic diagram showing a three-touch press applied on a touch device according to an embodiment of the present invention. This diagram is merely an example, which should not unduly limit the scope of the claims herein. One in ordinary skilled of the art should recognize many alternatives, variations, and modifications. As shown, a touch device 100 includes a touchscreen 110 having a flat surface area. The touchscreen 110 is a typical glass-based electronic material configured to be touch sensitive and operable of generating a position signal based on any touch such as finger press. Conventionally, single finger press and two-finger press has been characterized. According to an embodiment, a three-touch press is functionally characterized. In particular, the touch device is configured to allow its touchscreen 110 to detect the three-touch press 101 containing exact three touch points respectively denoted as touch 1, touch 2, and touch 3. In particular, the touchscreen 110 is able to distinguish numbers of touch point by receiving three separate position signals within a substantially short time and is able to process these position signals to generate a payload that describes the touch event.

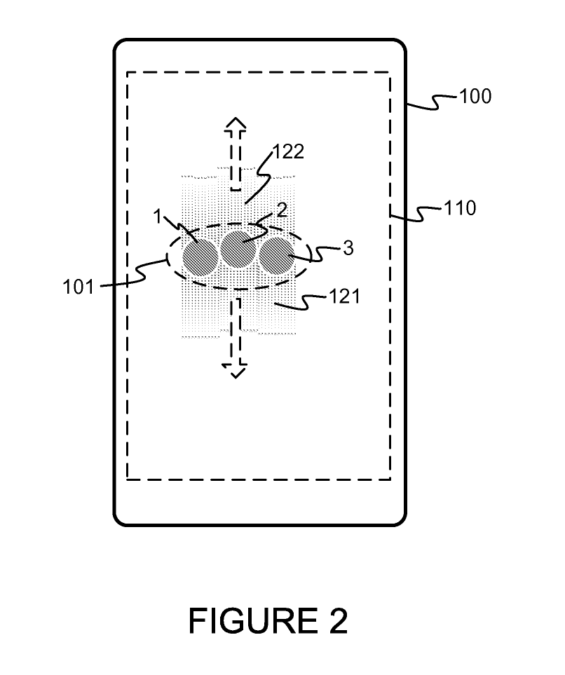

Like conventional touch device 100, the touchscreen 110 is also configured to detect a motion successive to the press. In another embodiment, the touchsreen 110 is configured to detect a stroke motion following the three-touch press. FIG. 2 is a schematic diagram showing a three-touch stroke motion along the touch device according to an embodiment of the present invention. This diagram is merely an example, which should not unduly limit the scope of the claims herein. One in ordinary skilled of the art should recognize many alternatives, variations, and modifications. As shown, after a three-touch press 101 is applied to the touchscreen 110 of the touch device 100, a stroke motion 121 or 122 applied along the touchscreen surface while the three touches 1, 2, and 3 are remained in contact with the touchscreen 110. In a specific embodiment, the stroke motion 121 is a substantially linear motion downward along the touchscreen 110 with three-touch objects (e.g, three fingers) moving together and the stroke 122 is a substantially linear motion upward along the touchscreen 110 with three-touch objects moving together. In fact, the stroke motion 121 or 122 can be along an arbitrary direction along the touchscreen 110 surface. In another specific embodiment, the stroke motion 121 or 122 ends with a lift motion so that the object(s) imposed the three touches lift above the touchscreen 110. This is schematically illustrated by multiple lines that are gradually faded in its darkness near the end of the stroke motion. Like the conventional touchscreen designated to detect the single-finger scroll or flick motion, the touchscreen 110 is able to detect the motion event characterized by the three-touch stroke motion and is able to generate another payload that describes the motion event.

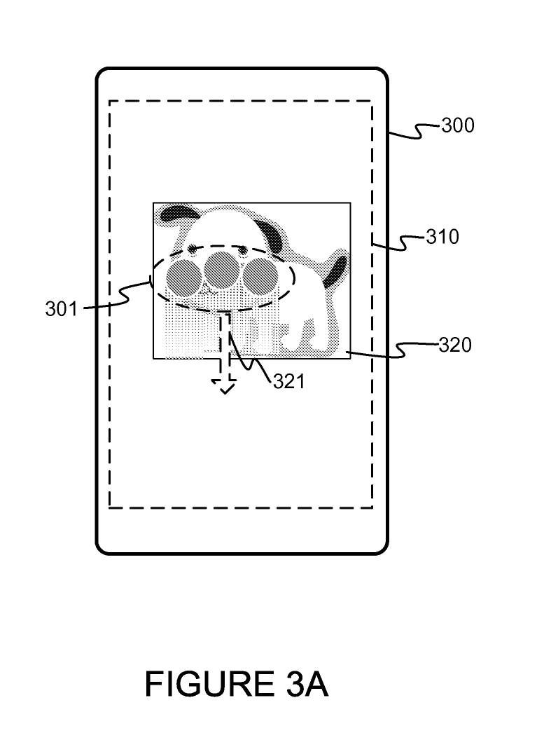

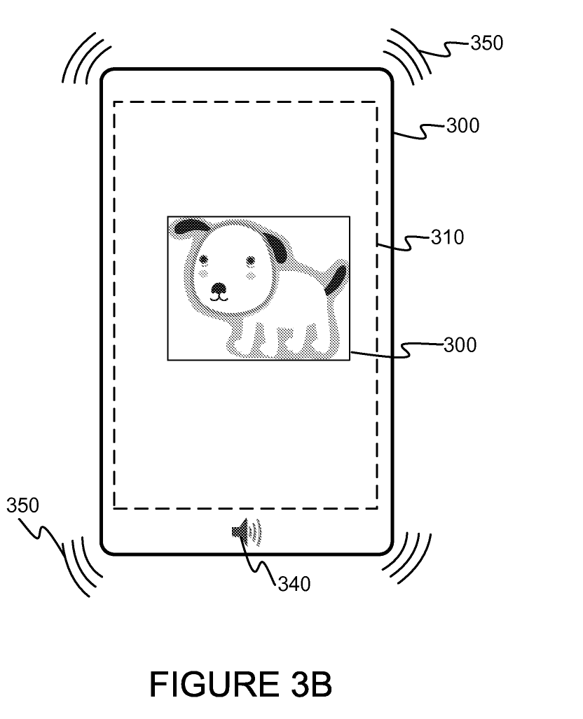

An object of this invention is to utilize this functional three-touch stroke gesture for providing one or more novel applications based on existing or newly developed mobile devices. Similar applications can also be implemented on any device, or toy, or personal item, or household item, building part that equipped with an enabled functional touchscreen. Merely by an example, FIG. 3A shows a schematic diagram of an application with the three-touch stroke motion applied on a graphic object displayed on a touch device according to an embodiment of the present invention. As shown, an image 320 is loaded on the display area 310 of a mobile device 300. The display area 310 is part of a touchscreen device which can be the same as the touchscreen 110 described in FIG. 2. A three-touch press 301 is applied onto a touchscreen area within the loaded image 320. For example, the three-touch press 301 can be formed by a user using his/her three fingers to have three tips respectively touching the screen position as denoted by corresponding three dots substantially at the same time. Right after the three-touch press occurs, a touch event characterized this contact having exact three touch positions can be created by the touchscreen 310 of the mobile device 300. Subsequently, a three-touch stroke motion 321 is initiated by start moving the three-fingers together while they all stay in touch with the touchscreen 321. The stroke motion 321, as saying by the word “stroke”, is a quick linear motion that ends with a lift with all three fingers leaving the touchscreen 321. Similarly, the touchscreen 321, and particularly the loaded image 320, is enabled to classify this three-touch stroke motion 321 as a payload since it is applied within the displayed area of said image 320. The payload is a simple description of a characterized touch-motion event which can be processed by an operation system installed with the mobile device 300 to generate a drive signal for triggering any tangible device response to the touch-motion event.

Merely through another example, FIG. 3B shows a schematic diagram of a tactile/audible response to the three-touch stroke motion applied on a graphic object displayed on the touch device according to an embodiment of the present invention. As shown in this example, through a user programmable application an instruction code is loaded in an event handler stored in the mobile device to define a specific response to the drive signal generated earlier from the detected touch-motion event based on the three-touch stroke motion 321. In an example, the response is a tactile response 350: that is, the mobile device is triggered to vibrate in response to the drive signal from the event handler. For almost all state-of-art mobile phones, the vibration mode is supported. In another example, the response can be an audible response 340: that is, the mobile device is triggered to play an audio (simple sound or a piece of music) in response to the drive signal from the event handler. Again, mobile phones are basically equipped with a music player and speaker to play the audio that is specifically associated with the loaded image 320 through the user programmable application. Of course, there are many alternatives, variations, and modifications. One in ordinary skilled of the art should not unduly limit the scope of the claims herein.

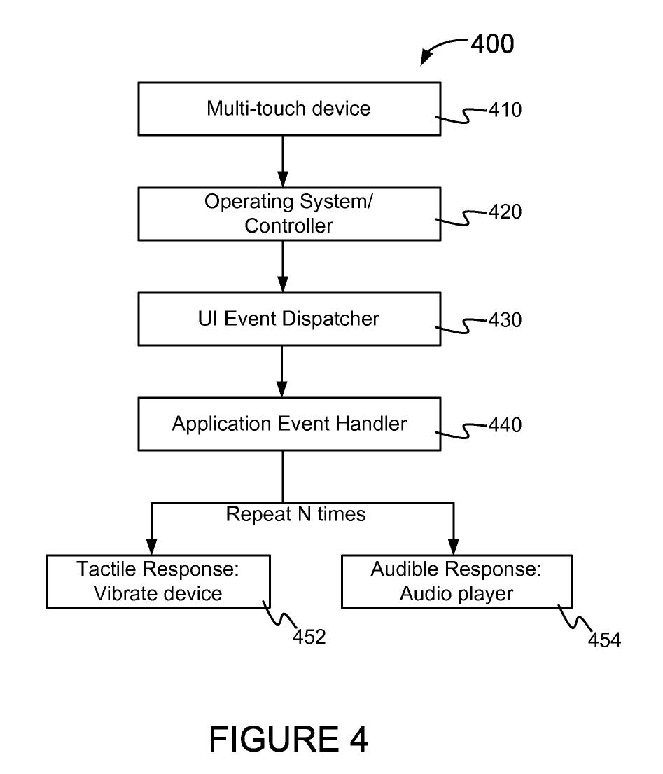

FIG. 4 is a block diagram showing a process flow in association with a system to initiate a three-touch stroke motion for inducing a tactile/audible response according to an embodiment of the present invention. This diagram is merely an example, which should not unduly limit the scope of the claims herein. One in ordinary skilled of the art should recognize many alternatives, variations, and modifications. As shown, a process flow of a three-touch stroke motion is initiated at a multi-touch device 410 operable within a system 400 to produce an event signal associated with a touch-motion event. The event signal is sent to a controller 420 (or for most mobile device an operating system is automatically used for conducting the required control function) of the system 400. The controller 420 includes a processor configured to process the event signal and classify the touch-motion event as a payload to characterize the corresponding three-touch stroke motion. The controller 420 further generates a drive signal carrying the payload and send the drive signal to a user-interface (UI) event dispatcher 430. Furthermore, the UI event dispatcher 430 publish the drive signal to allow a currently subscribed application event handler 440 to take the drive signal for inducing one or more functional responses.

In a specific embodiment, the multi-touch device 410 is configured to detect any touch event in association with a multi-touch position signal that senses both the position of each touch and successive motion of each touch. Particularly, the multi-touch device 410 can be configured to detect a novel three-touch press as proposed in FIGS. 1, 2, and 3A. Further, the multi-touch device 410 is also configured to detect the subsequent stroke motion (see FIGS. 2 and 3A) after the three-touch press. The multi-touch device 410 combines the detected position-sensitive information about the three-touch press and the motion-sensitive information about a stroke motion to produce an event signal. The controller 420 is configured to receive the event signal from the multi-touch device 410 and to process the event signal by classifying the specific touch-motion event associated with the three-touch press followed by the stroke and lift motion. The classifying process creates a payload data package providing description of the touch-motion event associated with the three-touch stroke motion. The controller 420 is further to generate a drive signal carrying the payload data package to a user-interface event dispatcher 430.

Referring to FIG. 4 again, the UI event dispatcher 430 is coupled directly to an application event handler 440 to allow the latter to subscribe at least one specific drive signal from all dispatched from the UI event dispatcher 430, depending on what is a currently launched application. In another specific embodiment, the application event handler 440 is programmed (or loaded a programmable instruction code) with a graphical application that enables one or more functional responses to the specific drive signal associated with the three-touch stroke motion currently subscribed from the event dispatcher 430. For example, the one or more functional responses include one or more tactile responses and/or one or more audible responses. The tactile response is simply to cause the system 400 to vibrate with certain frequency, which requires that the system to include a vibrate device 452. In an example, the system 400 is a mobile phone in which a vibrate device is almost a standard component. A default setting for the system 400 is enabled with said graphical application to have a tactile response to the three-touch stroke motion. The audible response is just to start playing an audio (sound or a piece of music) based on an audio file that is preprogrammed to associate with the touch-motion event. In an example, to enable the audio response, the system 400 at least includes an audio player 454 (such as a MP3 player) in association with a speaker. In yet another specific embodiment, the graphical application is a user-interface application launched for display graphical object directly on the multi-touch device 410. The user-interface application is configured to allow user to program some parameters to customize the final functional responses. For example, the application allows user to set a number of repeating the response no matter it is to vibrate or to play a song.

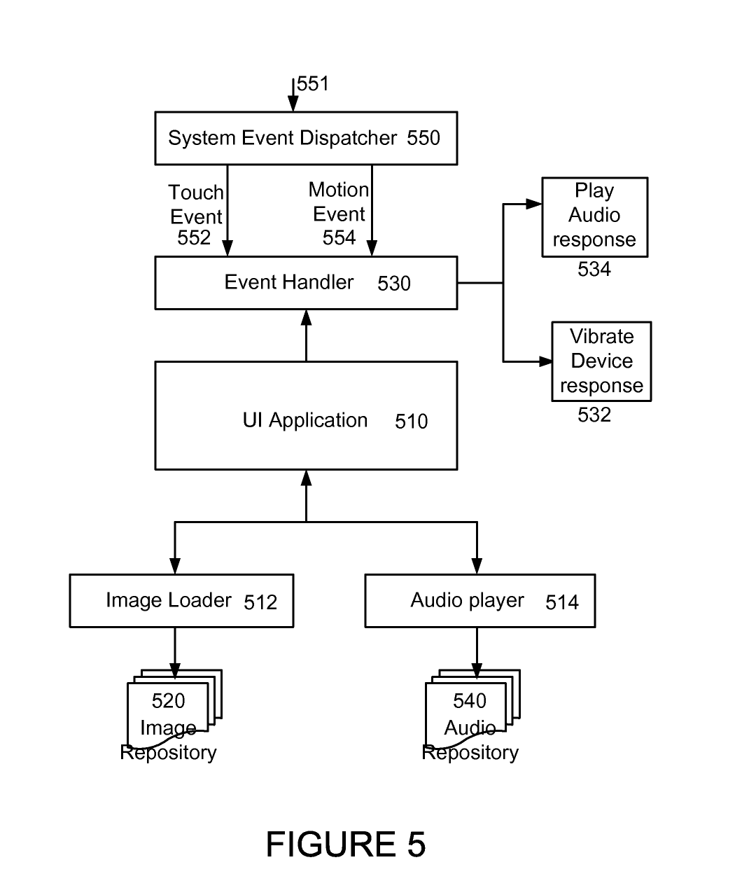

FIG. 5 is a functional block diagram of a user-interface application enabled with tactile and/or audible response to a touch-motion event according to an embodiment of the present invention. This diagram is merely an example, which should not unduly limit the scope of the claims herein. One in ordinary skilled of the art should recognize many alternatives, variations, and modifications. In an embodiment, the user-interface (UI) application 510 is launched within a system that is substantially the same as system 400 illustrated in FIG. 4. In particular, the UI application 510 is launched as an application to display at least a graphic object on a touchscreen, for example, part of a multi-touch device 410 as illustrated in FIG. 4. The functions of the UI application include mainly three folds. The first one is to enable a touch-motion event handler 530 to receive both a touch event 552 and a motion event 554 from a system event dispatcher 550. A particular touch-motion event associated with the UI application is a three-touch stroke motion. The second one is to allow an image or generally a graphic object be selected by a user via an image loader 512 to display on the touchscreen that is configured to detect any touch-motion events 551 provided for the system event dispatcher 550. It also allows user to use the UI application to select or change an audio file through an audio player 514 to be associated with the selected graphic object. The third one is to empower the event handler 530 to execute a drive signal (generated by an internal controller) to induce one or more functional responses to the particular three-touch stroke motion. A first response 532 is a tactile response by causing a vibration to the system. A second response 534 is an audible response by playing the audio file selected by the user.

The graphic object loaded by the UI application includes an image, a photo, a logo, a graphical text, a map, and a drawing and more from an image repository 520. In certain implementations, the photo image can be selected from one pre-stored in a memory device associated with the system. It also can be selected from one just downloaded from a cloud storage place or from public website through a wireless internet connection. It yet can be selected from one just taken by a camera built with the system. Similarly, the audio file can be customized by randomly selecting a predetermined list of audio files in audio repository 540.

In an embodiment, the system 400 shown in FIG. 4 for implementing the UI application bearing the function for providing tactile/audible response to three-touch stroke motion can be a mobile device selected from iPhone, Android phone, Windows phone, tablet computer, e-book, digital photo album. Correspondingly the controller 420 can be part of the internal operating system like iOS, Android, and Windows or can be an IC chip loaded with a specific firmware that is programmed to execute several simple applications including the UI application described above. For example, a digital photo album can be installed such an IC chip that is able to at least provide a tactile/audible feedback to the three-touch stroke motion applied on the displayed image. In another embodiment, the system 400 can have a simplified version having at least a touchscreen and an embedded IC chip loaded with the above UI application. And this system then can be installed to a part of any personal item (like garment or toy) or household items (like furniture with touchscreen), home-electronics (like flat-panel TV), building part (display wall). Particularly, a toy pet made with a touchscreen or touch pad (with or without an image) that is enabled with this application can be easily implemented to play a delighted sound that simulates real animal's sound or to vibrate in a designated manner.

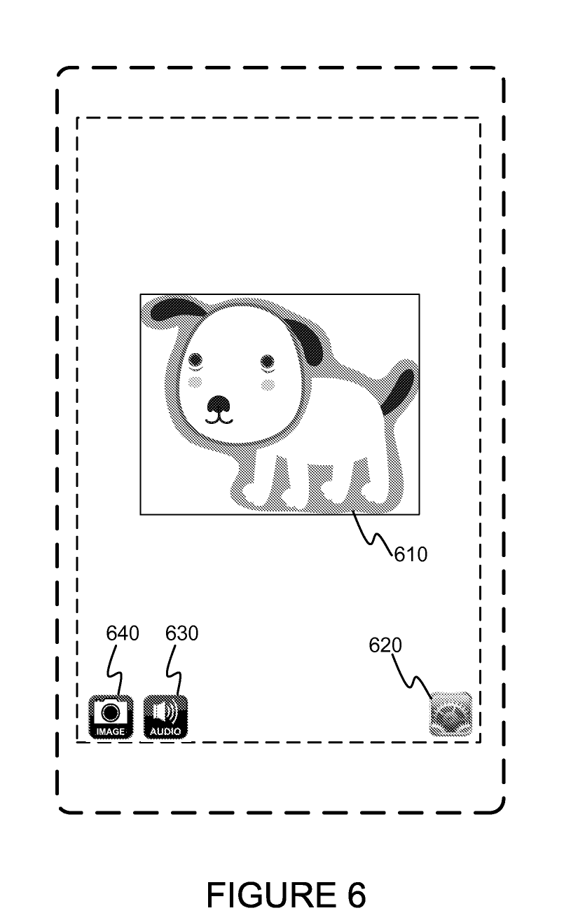

FIG. 6 is a simplified diagram showing an exemplary user-interface application having a set button, an image loader button, and an audio loader button according to an embodiment of the present invention. This diagram is merely an example, which should not unduly limit the scope of the claims herein. One in ordinary skilled of the art should recognize many alternatives, variations, and modifications. As shown, the UI application is launched on a display area of a touchscreen or touch pad. It has basically a set button (or menu) 620, an image loader button 640, and an audio loader button 630. The set button 620 is configured to make user-programmable selections on desired response factors. For example, a number of repeat can be selected to determine how many times that either the tactile response or the audible response will be repeated. User can also decide to turn off one type of response or turn on both types of responses. The image loader button 640 of course allows user to select any image stored in the system. For example, an image 610 is loaded on the display area (or part of the touchscreen). Once the image is selected through this application to display on the touchscreen, it automatically enables the corresponding event handler to recognize the drive signal based on the touch-motion event associated with the three-touch stroke motion applied onto the loaded image 610 on the touchscreen. Furthermore, the audio loader button 630 is configured to select a random audio file from a stored list. Once it is selected, the sound or piece of music will be played after the three-touch stroke motion is applied to the selected image 610 on the touchscreen.

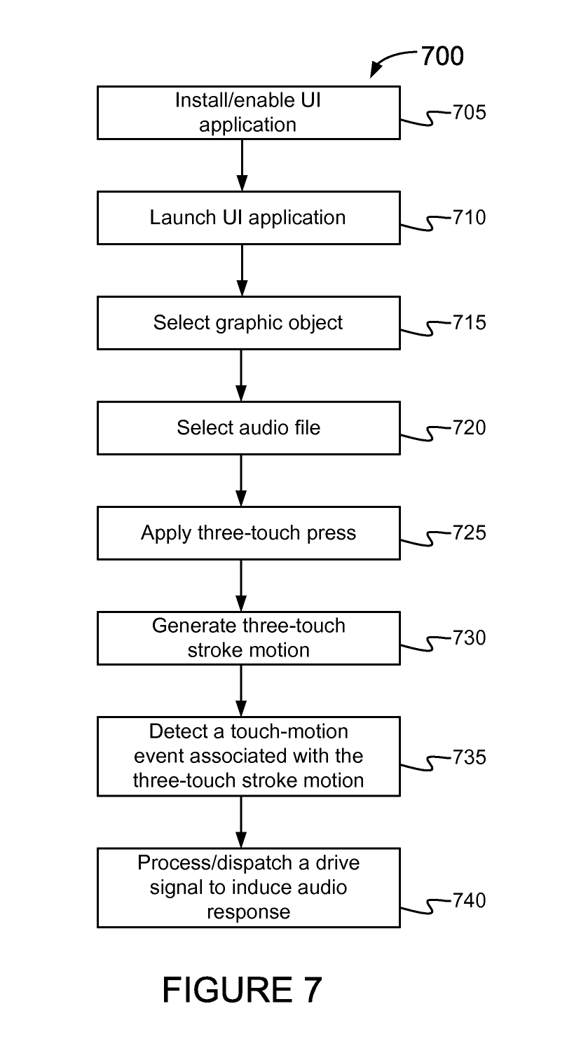

In an alternative embodiment, an object of the present invention is provide a method for providing tactile/audible response to three-touch stroke motion on a touchscreen. FIG. 7 is a flow chart showing a method for providing tactile/audible feedbacks to three-touch stroke motion in a user-interface application according to an embodiment of the present invention. This diagram is merely an example, which should not unduly limit the scope of the claims herein. One in ordinary skilled of the art should recognize many alternatives, variations, and modifications. As shown, a method 700 for providing tactile/audible response to three-touch stroke motion on a touch device includes following processes:
1. Install and enable a UI application (step 705);
2. Launch the UI application (step 710);
3. Use the UI application browse menu to select a graphic object (step 715);
4. Use the UI application sound menu to select a audio file (step 720);
5. Apply three-touch press on the touch device (step 725);
6. Apply three-touch stroke motion along the touch device (step 730);
7. Detect a touch-motion event associated with the three-touch stroke motion (step 735);
8. Process the touch-motion event to dispatch a drive signal to induce a default tactile response and/or an audio response (step 740).

As shown, the present method has a sequence of steps, which can be varied, modified, replaced, reordered, expanded, contracted, or any combinations thereof. Such steps may be performed alone or in combination with others, which are described or not even described. The steps can be performed in the order shown or in other orders, if desired. The steps also can be performed using a combination of hardware and software using other process steps. The steps also can be performed using hardware or other processes implemented using software and the like. Of course, there can be many other variations, modifications, and alternatives. Further details of the present method can be found throughout the present specification and more particularly below.

The above sequential steps are an instruction for implementing a mobile device UI application that manifest a system with a multi-touch enabled touchscreen or touch pad attached to the mobile device to use a three-point touch movement on an loaded graphic object to simulate a stroke causing the mobile device to vibrate or play a sound from a audio file or have both responses. In an implementation, the UI application is launched through a multi-touch device as shown in FIGS. 2, 3A, and 3B, wherein the multi-touch device is operable to detect many touch and motion events. In particularly, a novel functional gesture is introduced through the launching of the UI application to use three-fingers to make a simultaneous touch on the displayed image and move the three fingers together to simulate a (three-touch) stroke motion. Step 705 is executed to enable the touch device capability to detect and identify not only if there are exact three numbers of touches at a time but also determine a successive stroke motion with three-touches in a correlated fashion. Through the installation of the programmable instruction code in associated with the position sensing elements of the touch device, the three-touch stroke motion described in FIGS. 2 and 3A can be well classified into a specific touch-motion event. Step 705 also enables the controller to process the touch-motion event via both software and hardware like event dispatcher to send a drive signal carrying a payload of the three-touch stroke motion description and corresponding tactile/audible responses to an event handler, as seen in FIG. 4.

In an implementation, the launched UI application is substantially similar to one illustrated in FIG. 6, wherein the image loader button 640 represents the browse menu to execute step 715 to select a graphic object or simply an image file and the audio loader button 630 represents the sound menu to execute step 720 to select an audio file. The functional gesture introduced in FIGS. 1 and 2 of the present invention just provides a unique three-touch press (step 725) and applies a successive stroke motion (step 730) with three-touch move together along the touch device and lift the touchscreen together in a coherent fashion.

The enabled touch device (in step 705) is able to use step 735 to detect this three-touch stroke motion and produce a touch-motion event signal (see FIG. 4). The controller associated with the system (e.g., the mobile phone's operating system) then can process (in step 740) this touch-motion event signal to generate a payload for an event dispatcher (see FIG. 4) and a corresponding drive signal is dispatched to an event handler to trigger a predefined (by the UI application) tactile or audible response (step 740).

Some steps of the method 700 may be omitted and do not change the functionality of what the application intends to accomplish. For example, step 715 or step 720 may be canceled so that a touchscreen does not have to have a loaded image to allow the operability to detect the three-touch stroke motion enabled. For many applications, the method as described in FIG. 7 only needs a firmware-enabled touchscreen installed so that whenever a three-touch stroke motion is applied onto the touchscreen a pre-determined tactile or audible response can be trigger with a default vibration or sound-play (using a firmware to embed a default song file in a IC chip).

Other steps may be added with more functionality. For example, a step could be added to allow user to customize the specific feature of the tactile or audible response in many other ways for various different purposes. The vibration response can be set to repeat a number of times and the audio play can also be set to repeat two or more times or make a switch to another song after one song is play for a certain number of times or chosen to stop. The UI application can be further developed to add more features while not limit the scope of the claims herein.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A system for providing tactile and audible feedbacks to three-touch stroke motion, the system comprising:
a multi-touch device including a display area operable to produce an event signal by detecting any touch-motion event by one or more user-controlled objects, the touch-motion event including a three-touch stroke motion characterized by substantially simultaneous three-point touch followed by a stroke motion along the multi-touch device before lifting the user-controlled objects from the display area;
a controller configured to process the event signal and generate a drive signal for an event dispatcher; and
an event handler being coupled to the event dispatcher to subscribe the drive signal, wherein the event handler is configured to select a graphic object to display on the display area that is enabled with the drive signal specifically associated with the three-touch stroke motion applied to said graphic object to provide either a tactile response or an audible response or both.

2. The system of claim 1 further comprising a memory associated with the controller for storing at least a programmable instruction code configured to detect the exact number of touches by any user-controlled objects and classify the three-touch stroke motion to generate the drive signal to enable the tactile response or an audible response or both.

3. The system of claim 1 further comprising a memory associated with the event handler for storing at least a programmable instruction code configured to launch a graphical application to at least display the graphic object on the display area of the touch device that is enabled to respond to the drive signal.

4. The system of claim 3 wherein the programmable instruction code is stored as a firmware in an IC chip of the controller.

5. The system of claim 3 wherein the graphical application is a user-interface application.

6. The system of claim 3 wherein the graphical application comprises a browser menu configured to select an image from a group including one that is pre-stored in a memory device associated with the system, one that is instantly downloaded through associated wireless internet connection, and one that is taken by an associated camera before the graphical application is launched.

7. The system of claim 6 wherein the graphical application comprises a default setting to play a pre-stored audio to respond to the drive signal associated with the three-touch stroke motion applied on the selected image.

8. The system of claim 6 wherein the graphical application further comprises a default setting to enable a vibration response to the drive signal associated with the three-touch stroke motion applied on the selected image for any system that functionally supports vibrate.

9. The system of claim 6 wherein the graphical application comprises a sound menu configured to select an audio file for executing an audible response to the drive signal associated with the three-touch stroke motion on the selected image.

10. The system of claim 6 wherein the graphical application comprises a Repeat menu configured to select a number to repeat either a tactile response or an audible response or both responses to the drive signal associated with the three-touch stroke motion applied on the selected image.

11. The system of claim 1 wherein the multi-touch device is a touch screen device.

12. The system of claim 1 wherein the display area of the multi-touch device is a touchscreen of a mobile devices including one selected from iPhone, Android phone, Window phone, tablet computer, e-book, digital photo album.

13. The system of claim 1 wherein the display area of the multi-touch device is a touchscreen built on one object selected from a toy, a home-electromics, a tool, a machine, a furniture, a garment, a building part.

14. The system of claim 1 wherein the controller is a programmable chip with loaded firmware configured to detect and classify the three-touch stroke motion to a drive signal that can induce a tactile and/or audible feedback to the classified three-touch stroke motion.

15. The system of claim 1 wherein the controller is an operating system installed in any mobile devices, including one selected from iOS, Android, and Windows.

16. The system of claim 1 wherein the user-controlled objects comprise fingers and hand-held stylus.

17. The system of claim 1 wherein the graphic object comprises one selected from an image, a photo, a logo, a graphical text, a map, a drawing.

18. A method for providing tactile and/or audible feedbacks to three-touch stroke motion on a touch device, the method comprising:
enabling a user-interface (UI) application by storing a computer-readable code to a memory associated with an event handler, the computer-readable code being configured to respond to a drive signal generated by a controller by processing an event signal received from a touch device configured to detect any touch-motion event by one or more user-controlled objects;
launching the UI application;
selecting a graphic object associated with the UI application to display on a display area of the touch device;
selecting an audio file associated with the graphic object;
applying user-controlled objects to cause a touch-motion event characterized by exact three touches at a time on the displayed graphic object followed by a stroke motion along the touch device before lifting;
detecting the touch-motion event by the touch device to produce a first event signal associated with the three-touch stroke motion;
processing the first event signal by the controller to generate a first drive signal; and
dispatching the first drive signal to the event handler to play an audio based on the audio file.

19. The method of claim 18 further comprising:
setting a vibration response of the touch device as a default feedback in the UI application to the first drive signal.

20. The method of claim 18 further comprising:
selecting repeat number associated with the UI application to determine a number of times of repeating a vibration response and/or an audio-play response.

21. The method of claim 18 wherein the UI application is launched at a mobile device including at least an operating system as the controller and a touchscreen display area.

22. The method of claim 21 wherein the mobile device comprises one selected from iPhone, Android phone, Windows phone, tablet computer, e-book, digital photo album.

23. The method of claim 18 wherein the UI application is embedded in the controller as a part of processor firmware pre-loaded in an IC chip assembled with a touchscreen display area.

24. The method of claim 23 wherein the IC chip assembled with a touchscreen display area is installed as part of an object selected from a toy, a home-electronics, a tool, a machine, a furniture, a garment, a building part.

25. The method of claim 18 wherein processing the first event signal comprises classifying the first event signal received from the touch device by determining if there are exact three fingers/styluses to touch the graphic object at a time on the display area followed by the stroke motion and the lift motion.

26. The method of claim 18 wherein the user-controlled objects comprise fingers or stylus.

27. The method of claim 18 wherein the graphic object comprises one selected from an image, a photo, a logo, a graphical text, a map, and a drawing.

28. The method of claim 18 wherein the graphic object is one selected from an image library pre-stored in an associated memory device, an image downloaded through an associated wireless internet connection, and a photo taken by an associated camera right before launching of the UI application.

29. A functional gesture applying on a touch device comprising:
A substantially simultaneous three-finger press on the touch device configured to detect a position signal for each individual touch;
a stroke motion following the three-finger press wherein the three fingers remain in touch with the touch device; and
a lift motion at the end of the stroke motion wherein all fingers move away from the touch device;
wherein the three-finger press is applied on a graphic object displayed on the touch device and enabled by a user-interface application, and the three-finger press followed by the stroke motion and lift motion induces a tactile/audible response programmable by the user-interface application.

30. The functional gesture of claim 29 wherein the three-finger press comprises exact three touches detectable by the touch device.

31. The functional gesture of claim 29 wherein the stroke motion comprises coherently moving the three fingers together in one direction along the touch device.

32. The functional gesture of claim 29 wherein the tactile response is a default vibration response enabled by the user-interface application installed on any mobile device that supports vibrate.

33. The functional gesture of claim 29 wherein the audible response is a programmable response enabled by the user-interface application installed on any mobile device that supports digital audio play.

34. The functional gesture of claim 29 wherein the tactile/audible response is an embedded firmware stored in an IC chip installed on a toy including a touch pad.
